(19) United States
(12) Patent Application Publication
(10) Pub. No.: US 2012/0119144 A1
(43) Pub. Date: May 17, 2012

(54) LUMINANCE MATERIAL AND MANUFACTURING METHOD AND MANUFACTURE APPARATUS THEREOF

(75) Inventors: Shyan-Lung Chung, Tainan City (TW); Yen-Chun Liu, Kaohsiung City (TW); Shu-Chi Huang, Taoyuan County (TW); Feng-Sheng Chang, New Taipei City (TW); Huan-Yu Chen, Taichung City (TW)

(73) Assignee: BUREAU OF ENERGY, MINISTRY OF ECONOMIC AFFAIRS, Taipei City (TW)

(21) Appl. No.: 13/049,241

(22) Filed: Mar. 16, 2011

(30) Foreign Application Priority Data
Nov. 16, 2010 (TW) 099139441

(51) Int. Cl. C09K 11/64; C09K 11/80; B01J 19/00

(52) U.S. Cl. 252/301.4 F; 422/198

(57) ABSTRACT

A method for preparing an ester is provided. The method includes steps of mixing an acid and an alcohol in a reactive distillation column to generate a first gas mixture; transporting the first gas mixture out of the reactive distillation column; cooling down the first gas mixture for a phase separation to obtain a first liquid mixture in an upper phase; transporting the first liquid mixture back to the reactive distillation column; obtaining a second liquid mixture at a middle section of the reactive distillation column; transporting the second liquid mixture to a separative distillation column; and obtaining the ester at a bottom section of the separative distillation column.

### CROSS REFERENCE TO RELATED APPLICATIONS

The application claims the benefit of Taiwan Patent Application No. 099139441, filed on Nov. 16, 2010, at the Taiwan Intellectual Property Office, the disclosures of which are incorporated herein in their entirety by reference.

### FIELD OF THE INVENTION

The present invention relates to a luminance material, especially to a luminance material with an alpha-SiAlON, a manufacture method and a manufacturing apparatus thereof.

### BACKGROUND OF THE INVENTION

Under the demands of the energy saving and environmental conservation, the development of highly efficient, energy-saving and environmentally friendly “green” light sources becomes important research issue internationally and domestically. Generally, it is believed that the white LED will become important candidate to replace traditional light bulbs. Compared with incandescent light bulbs and fluorescent lamps, LED have several advantages, such as high luminescence efficiency (luminescence efficiency about one hundred lumens per watt, 100 lm/W), potential technical goal about 200 lm/W, low generated heat (less thermal radiation), low power consumption (low voltage, low starting electrical current), design flexibility (small size, light color/color temperature adjustability, pointing source, facility to develop into a compact size of the product), excellent reliability (long lifetime, low-temperature start and shock resistance), high response speed (workable under high-frequency operation), environmental protection (no mercury, low cost for waste disposal, hard to be broken) and ability to be flat packaged.

Currently, the patents of oxide and sulfide luminescence powders have been saturated and there is the issue of the patent monopoly. In addition, current commercial luminescence powders, such as YAG:Ce³⁺ (Y₃Al₅O₁₂:Ce³⁺, Yttrium Aluminum Garnet); TAG:Ce³⁺ (Tb₃Al₃O₁₂:Ce³⁺, Terbium Aluminum Garnet), still have the issues of the luminescence efficiency to be improved and the lack of thermal stability, and sulfide luminescence powders have the issues of toxicity and the poor chemical and thermal stability. As the current trend to the high-power for the white light LED, the operating temperature is accordingly increased, the luminescence color is changed due to the poor thermal stability of the oxide and sulfide luminescence powders, and consequently the issue of the luminescence color shift for the LED occurs. In contrast, nitride α-SiAlON luminescence powder has plenty of advantages, e.g. non-toxicity, good chemical stability, excellent thermal stability, high energy efficiency, high luminescence intensity and adjustability for the chemical composition and emission wavelength, so it has become a potential candidate for the LED luminescence material. However, currently the syntheses of the series of α-SiAlON luminescence materials need to be carried out under harsh conditions, such as high temperature, high pressure and long reaction time. Thus their productions are not easy, the production yields are small, the costs of apparatus and raw materials are high, the prices of α-SiAlON luminescence materials are expensive, and accordingly the applications of the series of α-SiAlON luminescence materials are limited. The deficiencies of a few conventional techniques are described as follows.

First, the solid state method is introduced. This method is a common method to synthesize the nitrogen oxides and nitrides. Usually the reaction precursor is placed under high temperature. The main reactant is Si₃N₄, when the nitrogen oxide or nitride luminescence powders are synthesized. Since the reactivity of Si₃N₄ is not high, the synthesis requires high temperature of about 1500 to 2000° C. The other reactants include metals, e.g. Ca, Sr, Ba, Eu, metal nitrides, e.g. AlN, Ca₃N₂, EuN, or metal oxides, e.g. Al₂O₃, CaCO₃ and SiO₂. After evenly mixing these ingredients, the nitrogen gas is introduced as the protective gas to prevent oxidation or decomposition of the reactants at high temperature. The pressure is usually controlled between 0.1 to 1.0 MPa, and the reaction lasts several hours. The products are usually subject to the post grinding process. Some studies have shown that the reactants need to be cold-isostatic-pressed to be turned into the reactant ingot or the hot pressure sintering apparatus is required for the reaction. Furthermore, this method requires the long-time calcination at high temperature, accordingly the powders are easy to be aggregated or sintered, and thus the product has large particle size. If the powders are post treated by the grinding process, the crystal defects may be generated during the grinding process, the luminescence efficiency is accordingly reduced, and the particle size cannot be effectively controlled. In addition, the apparatus, e.g. cold-isostatic-pressing apparatus, hot pressure sintering furnace, etc., is expensive, and the cost of the raw materials of the nitrides is high.

Next, the gas-pressing sintering (GPS) method is introduced. This method is similar to the solid state method, and also uses the metal nitride as a reactant. The difference between these two methods is that the GPS method adopts higher pressure in a range from 1 to 10 MPa and higher reaction operating temperature about 1800 to 2200° C., and does not need the hot pressure sintering, but adopts high nitrogen pressure to increase the opportunities of the contact between the reactants and the nitrogen gas. The products from the GPS method need to be post treated by the grinding and the other processes. Compared with the solid state method, the GPS method has the advantages of reducing the amount of flux and the reaction time. Although the sintering of the nitrogen oxides or nitrides can proceed at high temperature and under the nitrogen gas with normal pressure like the solid state method. The atomic mobility under the normal pressure is lower due to the covalent bonding, so more flux is needed for the sintering under normal pressure, and accordingly the structural strength is lower. If the nitrogen pressure is increased, evenly agglomerated luminescence powders can be obtained in a relatively short time. In addition, the α-Si₃N₄ or α-SiAlON tends to decompose to generate Si when the reaction temperature is higher than 1800° C., the sublimation or decomposition of the reactants and products can be reduced by increasing the pressure. However, since the reaction temperature and pressure by using GPS method are very high, the construction cost of apparatus is high with the safety concern, so the GPS method is not suitable for industrial mass production. Besides, the products by using GPS method are subject to the complex grinding processes, and a large number of defects in the luminescence powders may occur with the reduction of the luminescence efficiency. Moreover, the cost of the nitride raw materials is high

Another method, gas-reduction and nitridation method (GRN), is introduced as follows. This method for synthesizing nitrogen oxide luminescence powders is more effective and economic as compared with the previous two methods. This method usually uses oxide as a reaction precursor, which is simply put in the aluminum oxide or the quartz tube filled with the NH₃ or NH₃—CH₄ gases, which work as a reducing agent and a nitrogen source. The reaction temperature is about 1300 to 1600° C. The NH₃ or NH₃—CH₄ gases will decompose to generate H₂ and N₂ gases at high temperature, so the oxide can be chemically reduced into the nitride. Compared with the previous two methods, The GRN method has the advantage of lowering the reaction temperature by about 200° C. in the synthesis of α-SiAlON luminescence powder. In addition, the reaction by using the GRN method is usually carried out at normal pressure, and the oxide is usually used as the reactant, so there is no need to use the expensive apparatus and reactants. Therefore, the cost by using the GRN method is lower than that by using the solid state method or the GPS method. Besides, the reducing gas can solve the issue of residual carbon by using carbothermal reduction method. The particle size by using the GRN method is smaller than that by using the solid state method, so the post grinding processes may be unnecessary. However, the GRN method has some disadvantages that the reaction is carried out at high temperature by using the explosive NH₃—CH₄ gases, the reaction cannot proceed in the mass production scale, the reaction is extremely dangerous, and long reaction time is required with high energy consumption.

There is another method, carbothermal reduction method (CRN). This method is similar to the GRN method, and the difference between these two methods is that the CRN method uses the carbon powder as a reducing agent, and uses the nitrogen gas as a nitrogen source. The CRN method also uses the oxide as the precursor, which is mixed with the carbon powder for the reaction at high temperature and under nitrogen gas. In this reaction, since the carbon is easily reacted with the oxygen at high temperature to generate CO, the nitrogen enters the oxygen vacancies to form the nitride. This method has the advantages that the costs of the apparatus and reagents are as low as those for GRN method, and the reaction temperature and pressure are low as well. The CRN method has the disadvantages that the carbon amount in the reaction needs to be accurately controlled, the excess carbon will result in the formation of SiC at high temperature, and the unreacted carbon will greatly reduce the optical properties of the product and seriously affect the luminescence intensity. In order to increase the luminescence intensity, the steps to remove carbon by putting the raw product in the no-carbon air and at high temperature for the post treatment are required, this will increase the complexity of the whole processes, and the high temperature heat treatment may result in larger particle size.

There is another method, hydrothermal method. This method is less frequently applied to the synthesis of nitrogen oxide luminescence powders, but more frequently applied to the synthesis of oxide luminescence powders. This method usually adopts the nitric acid compounds as the reactants, which are soluble in the solvent. When it is necessary, the NaOH is used to control the pH value of the solution. The solution is first stirred at low temperature about 200° C., and then the reactants will precipitate. These precipitates, i.e. precursors, are water-washed, centrifugated, filtered and dried, and then put into the nitrogen gas furnace for the calcinations, where the hydrogen gas is introduced as a reducing gas. This method has the advantages that the reactants are more evenly mixed through the steps of the dissolution and precipitation of the reactants, and the processes are energy-saving, since the calcination temperature is about 1000° C. This method has the disadvantages that the whole processes are complicated, there is a safety concern by using the hydrogen for the reduction reaction, the crystalline phase of the product is not strong, and the luminescence efficiency is low. All these disadvantages are needed to be improved.

The general combustion synthesis method introduced here is the general combustion synthesis method for synthesizing α-SiAlON ceramic materials. In this method, the reactants can be metals, metal oxides, metal nitride, etc., and are evenly mixed and then put into the reactor, where the nitrogen pressure is set to the extremely high pressure, about 2.0 to 8.0 MPa, and then the reactants are ignited. This method has the following advantages: simple processes, less energy consumption, simple apparatus, capability of mass production and low cost. However, in order to enhance the conversion rate, the reaction must be carried out under very high pressure, so there is safety concern for the synthesis, and accordingly it is less suitable for the industrial application. If the reaction pressure is not so high, any inadequate control may result in the agglomeration of the product and the inability to ignite, accordingly the conversion rate becomes low, and the complex grinding processes are required. In addition, since the reactions are involved in the processes of rapidly heating and cooling, the products (in the case of the powders) may contain high concentrations of crystalline defects, resulting in the poor luminescence intensity.

Therefore, in view of the deficiencies of the prior arts and based on the understanding of the above-mentioned problems and the needs of technologies and industries, the inventors of the present invention invent the “α-SiAlON luminance material and manufacturing methods and manufacturing apparatus thereof”. The α-SiAlON luminance material is the nitrogen oxide luminance material with the main lattice of SiAlON, and has the properties of high luminescence intensity, good thermal stability, easy fabrication, low production costs, high purity for the products and the ability to solve the deficiencies of the conventional techniques.

### SUMMARY OF THE INVENTION

The present invention provides the α-SiAlON luminance material with high luminescence intensity and good thermal stability, the manufacturing method with simple processes, easy production and low production costs, and the apparatus for manufacturing the above α-SiAlON luminance material by the above manufacturing method.

In accordance with one aspect of the present invention, a method of manufacturing a luminescence material having an alpha-SiAlON is provided. This method includes the steps of providing a precursor of the alpha-SiAlON; mixing an igniting agent with the precursor to obtain a reaction mixture; and combusting the igniting agent to trigger a reaction of the reaction mixture so as to obtain the luminescence material.

In one embodiment, the method further includes a step of placing the reaction mixture into an adiabatic device.

In one embodiment, the method further includes a step of disposing an insulation powder between the reaction mixture and the adiabatic device.

In one embodiment, the precursor includes at least a reaction ingot, which is covered by the igniting agent during the step of mixing the igniting agent with the precursor.

In one embodiment, the step of combusting the igniting agent is performed by heating the reaction mixture.

In one embodiment, the igniting agent includes one selected from a group consisting of a Ti/C mixture, an Mg/Fe₃O₄ mixture, an Al/Fe₃O₄ mixture, an Al/Fe₂O₃ and a combination thereof.

In one embodiment, the igniting agent includes an Mg/Fe₃O₄ mixture having a molar ratio of the Mg to the Fe₃O₄ in a range of 1 to 8.

In one embodiment, the precursor includes a solid nitrogen source including one selected from a group consisting of an NaN₃, a KN₃, a Ba₃N₂ and a combination thereof.

In one embodiment, the precursor includes an ammonium halide source.

In one embodiment, the method further includes a step of placing the reaction mixture into a chamber.

In one embodiment, the precursor includes plural reaction ingots to be mixed with the igniting agent, and the step of combusting the igniting agent is performed by sequentially heating the plural reaction ingots.

In accordance with another aspect of the present invention, a luminescence material is provided. The luminescence material includes an alpha-SiAlON, and has a composition formula of Mₓ(Si, Al)₁₂(O, N)₁₆:A_{y}, wherein the M is a cation, the A is an ion of an activator, the x is a relative molar number of the M, and the y is a relative molar number of the A.

In one embodiment, the luminescence material further includes at least an element being one selected from a group consisting of a sodium, a chlorine and an iron.

In one embodiment, the luminescence material further includes a sodium chloride.

In one embodiment, the M includes at least an element being one selected from a group consisting of an Mg, a Ca and a Y.

In one embodiment, the A includes at least an element being one selected from a group consisting of an Eu, a Ce, a Tb and a rare earth element.

In accordance with a further aspect of the present invention, an apparatus for manufacturing a luminescence material having an alpha-SiAlON is provided. The apparatus includes an adiabatic device accommodating a raw material for manufacturing the luminescence material; and a heater disposed adjacent to the adiabatic device for heating the raw material to obtain the luminescence material.

In one embodiment, the apparatus further includes a chamber, wherein the adiabatic device and the heater are disposed inside the chamber.

In one embodiment, the apparatus further includes an insulation powder disposed between the raw material and the adiabatic device.

In one embodiment, the insulation powder includes a ceramic powder.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is the schematic diagram showing an apparatus for manufacturing an α-SiAlON luminance material in one embodiment of the present invention;

FIG. 2 is the schematic diagram showing an ingot and the preparation of a reaction ingot in one embodiment of the present invention;

FIG. 3 is the schematic diagram showing a structure of an adiabatic apparatus in one embodiment of the present invention;

FIG. 4 is the schematic diagram showing the reaction ingot disposed in the adiabatic apparatus in one embodiment of the present invention; and

FIG. 5 is the schematic diagram showing the ingredient analysis for the α-SiAlON luminance material in one embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

Based on the inventors' experiences on syntheses and developments of the nitride ceramic powders, mainly AlN and Si₃N₄, and the techniques of the combustion syntheses, in view of the issues and deficiencies of the conventional syntheses of the nitrogen oxide α-SiAlON luminance material, the inventors invent a novel method for synthesizing the nitrogen oxide α-SiAlON luminance material by overcoming the above issues and deficiencies. The method of the present invention utilizes the automatic combustion spread jamong the reactants at high temperature for the synthesis, and has the advantages of fast reaction, energy saving, easy processes, low synthesis pressure, simple apparatus, low cost of the raw materials and excellent performance of the products.

The SiAlON luminescence powder of the present invention has the general chemical formula: Mₓ(Si, Al)₁₂(O, N)₁₆:A_{y}, where its main lattice is formed by silicon nitride, the silicon nitride bonds in some parts of the silicon nitride are replaced by the aluminum oxide bonds and aluminum nitride bonds, the cation of the element M is used to balance the electrical charge of the main lattice and the ion of the doped activator, M is the element of the cation, Si is silicon element, Al is aluminum element, O is oxygen element, N is nitrogen element, A is the element of the activator ion, x is the molar number of M, and y is the molar number of A. First of all, the apparatus of the present invention and parts of the manufacturing processes are generally described as follows. The M of the cation in the main lattice can be a metal selected from Mg, Ca, or Y; while the A of activator ion is selected from Eu, Ce, Tb or rare earth elements.

Certainly, the element M of the cation can also be replaced by other elements or compounds. Please refer to the following Table 1.

TABLE 1

| | Substituents | Influences |
|---|---|---|
| M | Ca is replaced with CaO. | The wavelength will shift to shorter |
| | | wavelength (i.e. the color is changed |
| | | from yellow to green). |
| | Ca is replaced with Mg. | No wavelength shift. |
| | Ca is replaced with Y. | The wavelength will slightly shift to |
| | | longer wavelength (i.e. the color is |
| | | changed from yellow to a color |
| | | between yellow and orange). |
| | Ca is partially replaced | The wavelength will slightly shift to |
| | with Y (i.e. two metal | longer wavelength. |
| | elements coexist). | |
| | Ca is replaced with Y₂O₃. | The wavelength will slightly shift to |
| | | shorter wavelength, but not much. |
| | Ca is replaced with MgO. | The wavelength will shift to shorter |
| | | wavelength (i.e. the color is changed |
| | | from yellow to green). |
| | The amounts, not the | The wavelength will slightly shift to |
| | relative ratio, of Ca, Mg | longer wavelength. |
| | and Y increase. | |

Besides, the A of the activator ion can also be replaced with other elements or compounds. Please refer to the following Table 2.

TABLE 2

| | Substituents | Influences |
|---|---|---|
| A | Eu₂O₃ is replaced with | The wavelength will shift to shorter |
| | CeO₂. | wavelength (i.e. the color is changed |
| | | from yellow to green). |
| | The amount of Eu₂O₃ is | The wavelength will slightly shift to |
| | increased. | longer wavelength (i.e. the color is |
| | | changed from yellow to a color |
| | | between yellow and orange). |
| | The amount of CeO₂ is | The wavelength will shift to longer |
| | increased. | wavelength. |
| | Eu₂O₃ is replaced with | Almost no luminescence properties |
| | Nd₂O₃ or Dy₂O₃. | (hardly luminescent). |
| | Eu₂O₃ is replaced with | The wavelength will slightly shift to |
| | Eu or EuN. | longer wavelength (i.e. the color is |
| | | changed from yellow to a color |
| | | between yellow and orange). |
| | Eu₂O₃ is replaced with | The wavelength will slightly shift to |
| | Yb₂O₃. | longer wavelength. |
| | When Eu, EuN, Eu₂O₃ or | The luminescence intensity is |
| | CeO₂ is used as a main rare | enhanced. |
| | earth ion, the small amount | |
| | of Nd₂O₃ or Dy₂O₃ is added. | |

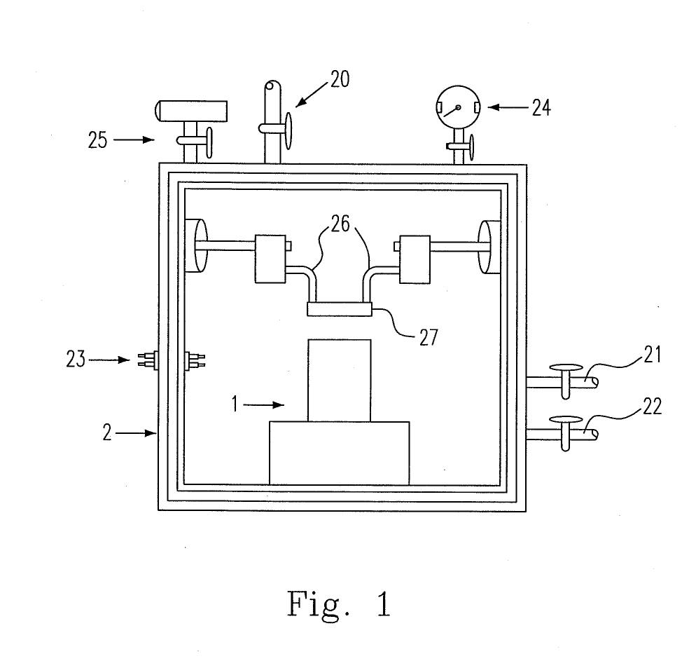

Please refer to FIG. 1, which is the schematic diagram showing an apparatus for manufacturing an α-SiAlON luminance material in one embodiment of the present invention. In FIG. 1, the chamber 2 has an air inlet 21 and an air outlet 20, which are usually responsible for the specific working gases being input into and output out of the chamber 2. The chamber 2 also includes a vacuum port 22, specifically used for the vacuum pumping of the chamber 2. A manometer 24 and a vacuum gauge 25 are disposed on the chamber 2 for measuring the pressure inside the chamber 2 and the vacuum level, respectively. In addition, the chamber 2 also has a thermometer port 23 used to set a thermometer (not shown in FIG. 1). Usually thermometer port 23 is a thermocouple wire to connect the thermocouple contact part (not shown in FIG. 1) inside the chamber 2 with the temperature measuring instrument (not shown in FIG. 1) outside the chamber 2.

Please continue to refer to FIG. 1. In FIG. 1, an adiabatic device 1 is used to be loaded with the raw material of the α-SiAlON luminescence materials in the present invention. A heater 27 is hung on the upper portion of the adiabatic device 1, is usually a tungsten coil, and is connected with the wire 26 for providing the power to the heater 27. When the raw material is placed in the adiabatic device 1, the reaction can happen by heating the raw material with the heater 27 to obtain the α-SiAlON luminescence material of the present invention.

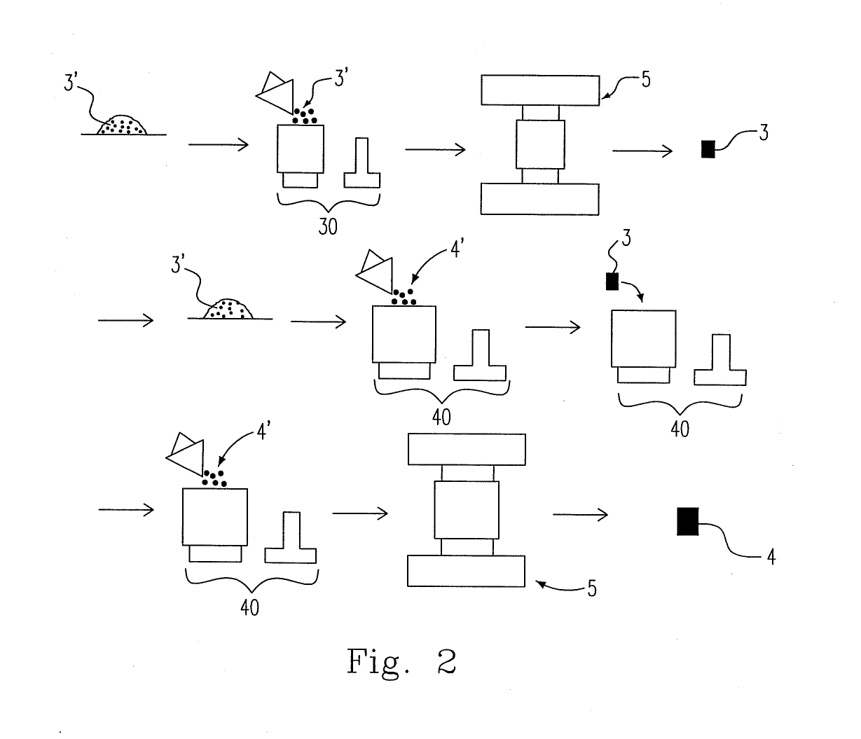

The present invention also discloses a method for manufacturing α-SiAlON luminescence material. The method includes the following steps: first providing an ingot; mixing a combustion initiator (or igniter) with the ingot to form a reaction ingot; and heating the combustion initiator for the combustion to cause the reaction of the reaction ingot so as to obtain the α-SiAlON luminescence material, where the reaction is usually a nitridation reaction. Regarding the ingot and the preparation of the reaction ingot, please refer to FIG. 2, which is the schematic diagram showing an ingot and the preparation of a reaction ingot in one embodiment of the present invention.

In FIG. 2, the ingot raw material 3′ is usually a powder, put into an ingot mold 30, and then is pressed by a mold press 5 to be turned into ingot 3. The raw material 4′ of the combustion initiator is usually a powder, and is put into the reaction ingot mold 40. Then the ingot 3 is put into the reaction ingot mold 40, and additional raw material 4′ of the combustion initiator is supplemented into the reaction ingot mold 40. After then, the mold press 5 is used to press the raw material 4′ of the combustion initiator and the ingot 3 together inside the reaction ingot mold to form a reaction ingot 4. Therefore, it can be seen from FIG. 2 that the better way to mix ingot raw material 3′ and raw material 4′ of the combustion initiator together is performed by entirely covering or coating the ingot 3. This way has the advantages of easy ignition and complete combustion, since the heater 27 provide the heat outside the reaction ingot 4 and the combustion initiator covering the whole outer surfaces of the ingot 3.

The covering combustion initiator has the following functions: firstly, by the rapid combustion speed and the generated high temperature, the combustion initiator can provide sufficient heat in a very short time to the reactants inside the reaction ingot for the decomposition reaction of the reactants and the formation reaction of the nitrogen oxides; Secondly, the resultant after the combustion of the combustion initiator is structurally dense to decrease the outward leakage of the nitrogen gas and to help the retention of nitrogen gas generated from the solid nitrogen source inside the reaction ingot so as to facilitate the formation of nitrogen oxides; and additionally, when the combustion initiator is ignited, the combustion will continue, so the heater can be turned off for the energy saving. Since the combustion initiator is contacted with the ingot, so the heat transfer efficiency is quite high and more effective than the way of using the heater. The combustion initiator can be selected from Ti/C mixture, Mg/Fe₃O₄ mixture, Al/Fe₃O₄ mixture, Al/Fe₂O₃ mixture or the mixture of the combinations of any two, three or all the above mixtures.

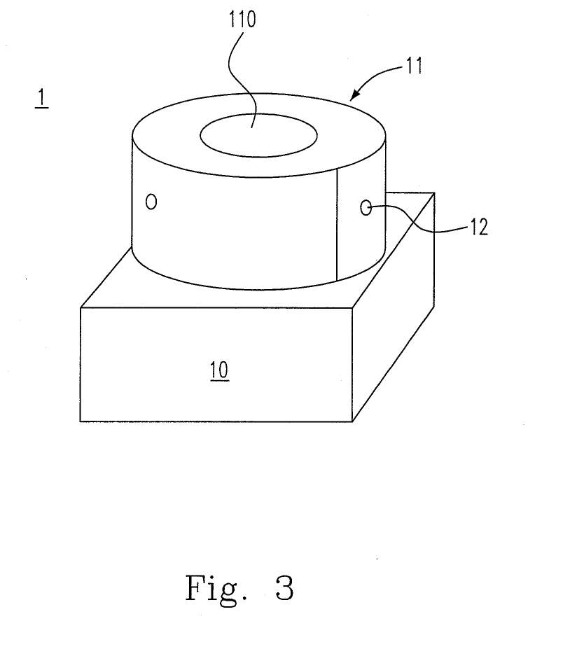

Please refer to FIG. 3, which is the schematic diagram showing a structure of a adiabatic apparatus in one embodiment of the present invention. In FIG. 3, the adiabatic device 1 includes a base 10, on which a container 11 is disposed. The container 11 has an inside space 110 for accommodating the reaction ingot 4 (see FIG. 1). In addition, a hole 12 can be formed on the container 11 to accommodate a thermocouple contact part (not shown in the figure) so as to measure the surface temperature of the adiabatic device 1.

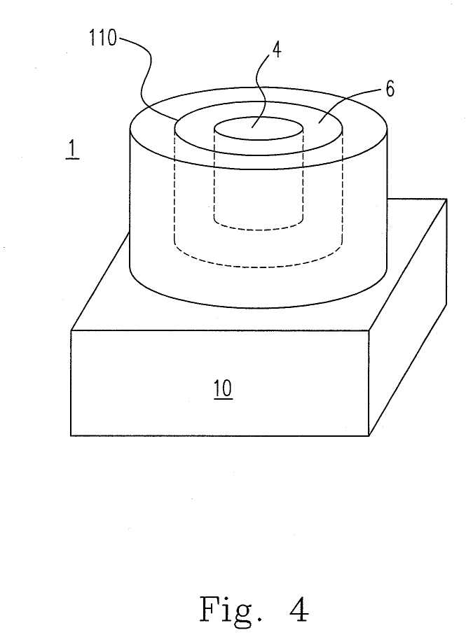

Please refer to FIG. 4, which is the schematic diagram showing the reaction ingot disposed in the adiabatic apparatus in one embodiment of the present invention. In FIG. 4, the adiabatic device 1 has a base 10, on which the container 11 is disposed. The container 11 has a space 110, in which the reaction ingot 4 is placed. Since there exists the dimensional tolerance for the manufactured reaction ingot 4, a gap (or clearance) between the reaction ingot 4 and the inner wall of the container 11 is designed to avoid the damage on the surfaces of the reaction ingot 4 resulting from the collisions between the reaction ingot 4 and the container 11 when the reaction ingot 4 is put into the space 110. However, the gap between the reaction ingot 4 and the inner wall of the container 11 may result in the air convection and the subsequent heat loss. Thus, the insulation powder is filled into the gap between the reaction ingot 4 and the inner wall of the container 11. Usually the insulation powder is a ceramic powder, and in addition to the above function of reducing the heat loss, is able to retard the escape of the gas generated from the solid nitrogen source so as to promote the contact between the reactants and nitrogen gas. Accordingly, the conversion rate can be increased, the phenomenon of agglomeration can be diminished, and the luminescence intensity of the product can be boosted.

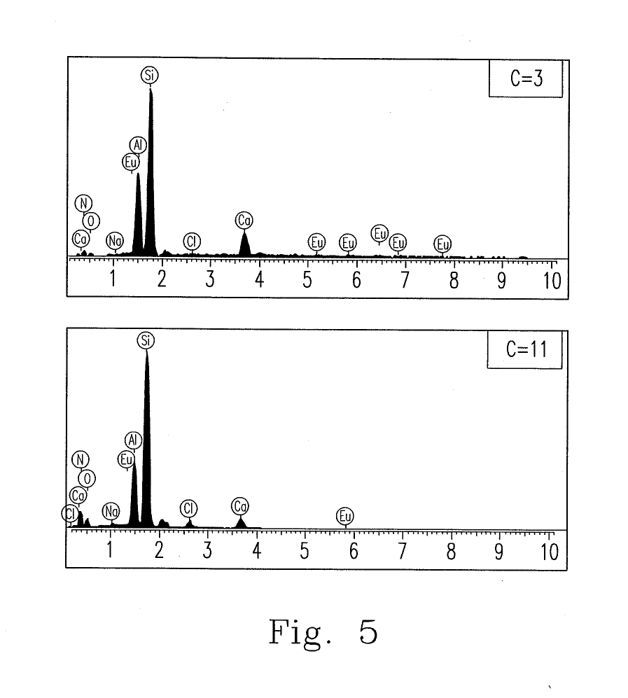

Please refer to FIG. 5, which is the schematic diagram showing the ingredient analysis for the α-SiAlON luminance material in one embodiment of the present invention. It can be seen from FIG. 5 that the products contain chlorine and sodium, and therefore the sodium chloride exists.

Overall, the adoption of the adiabatic device has the following benefits: firstly, the heat insulation material itself has the effect of thermal conservation, can diminish the phenomenon of thermal convection resulting from the nitrogen gas escaped from the internal nitrogen source, and can reduce the direct dispersion of the heat radiation energy to the outside, so that the reaction temperature is higher than that by using the conventional techniques, the duration of the high temperature is longer as well, and the luminescence intensity can be raised; secondly, with the higher reaction temperature and longer time period at high temperature, the purity of the product can be raised to reduce the impurities in the product without the necessity of the water-washing processes so as to diminish the complexity of the manufacturing processes; in addition, there is the ceramic powder between the adiabatic device and the reaction ingot, so that the powder brought out by the escaped gas from the internal reaction ingot can be filtered and blocked by the ceramic powder so as to reduce the smudge on the container 11; and furthermore, less combustion initiator is required to reach the desired reaction temperature by the adoption of the adiabatic device 1, so the production costs can be reduced and the energy utilization efficiency can be raised.

To achieve the above purposes, a method for preparing a luminescence material with alpha-SiAlON in accordance with the present invention can be performed by the following steps: firstly, mixing a combustion initiator (or an igniter) with an ingot to form a reaction ingot; and heating the combustion initiator to initiate the combustion and causing the reaction ingot to undergo the nitridation reaction so as to prepare the luminescence material with the alpha-SiAlON. The combustion initiator described here is the combustion initiator raw material 4′ described above, and the way of covering the ingot with the combustion initiator as described previously is a good choice.

The step of putting the reaction ingot into the adiabatic device is not repeated here. Furthermore, the adiabatic device is not limited to accommodate only a single reaction ingot, but can accommodate more than one reaction ingot. Besides, as referring to FIG. 2, if the reaction ingot mold 40 is large enough, after filling partial combustion initiator raw material 4′, plural ingots 3 can be placed inside the reaction ingot mold 40 and the following steps as described above remain unchanged. In such a way, a large-volume reaction ingot containing a plurality of ingots 3 can be prepared. In addition, certainly, a plurality of reaction ingot 4 covered with combustion initiator raw materials 4′ can be placed together into the space 110 of the container 11, as referring to FIG. 3. The sequence of the ignition can be simultaneous or successive ignition. The combustion initiator raw material can be a mixture of magnesium and iron oxide (e.g. Fe₃O₄), and the molar ratio of magnesium to iron oxide can be one to eight.

In addition, the ingot can contain a solid nitrogen source or a ammonium halide source. The ammonium halide has the following functions: (1) its decomposition reaction is an endothermic reaction, can reduce the combustion temperature, and can slow down the decomposition of the solid nitrogen-containing compound, so that solid nitrogen source can be more fully utilized; (2) halogen generated from the decomposition of the ammonium halide can react with the metal to form metal halide, which is an activator able to facilitate the formation of nitride; (3), the halogen from the ammonium halide reacts with the metal vapor from the decomposition of the solid-state nitrogen-containing compound to form the salt (metal halide) so that the escape of the metal vapor can be diminished and erosion by the metal vapor on the manufacturing apparatus can be reduced. The solid-state nitrogen source has the following functions: (1) it can provides the nitrogen source after the thermal decomposition; (2) it has high density of nitrogen uniformly distributed in the reaction ingot, and the nitrogen generated from the thermal decomposition can fully contact with the metal powder without the extremely high pressure as the gaseous nitrogen source is adopted; (3) the metal vapor generated from the decomposition can catalyze the metal nitridation reaction; (4) the metal vapor generated from the decomposition can react with the halogen from the decomposition of ammonium halide to form the salts to reduce the erosion by the metal vapor on the apparatus, and on the other hand the salt can be used as a flux to provide the flowing state for the sintering at high temperature so as to facilitate the reaction. The solid nitrogen source can be selected from NaN₃, KN₃, Ba₃N₂, or certainly the combinations of any or all the foregoing compounds.

Please refer to FIG. 1, the above manufacturing methods can be performed within the chamber 2, on which the adiabatic device 1 is placed as shown in FIG. 1, and the arrangement of the adiabatic device 1 can be referred to FIG. 4. In such way, the region of the whole reaction can be more easily controlled, and the control variables for the production can also be more effectively controlled.

The nitrogen pressure required in the method for synthesizing the nitride luminescence material in the present invention is related with the following factors: the amount and variety of the solid-state nitrogen-containing compound; the relative dimensions of the reaction ingot and the thickness of the outer covering combustion initiator; the variety, particle size and density of the combustion initiator; and whether the adiabatic device is adopted or not. The properties of the alpha-SiAION luminescence material can be controlled by the composition of the reactants, the composition of the combustion initiator, the size and density of the reaction ingot, the reaction temperature and nitrogen pressure. Several embodiments are described in the following. However, the actual disposition, adopted method, manufacturing apparatus or the ratio of the raw materials is not necessary to fully comply with the following embodiments described in the present invention. The skilled person in the art can make various changes or modifications without deviating from the spirit and scope of the present invention. Several embodiments are described below.

### Embodiment 1

Ca, Si, Al, Al₂O₃, Si₃N₄, NaN₃, NH₄Cl and Eu₂O₃ are uniformly mixed according to the molar ratio of 0.8:9.2:2:0.4:0:9.936:4.829:0.03, and then are pressed into the cylindrical ingot with the diameter of 1.7 cm and the height of 1.7 cm by using the mold press. Then Mg and Fe₃O₄, i.e. the combustion initiator raw material 4′ shown in FIG. 2 are uniformly mixed according to the molar ratio of 4:1. This mixture is used to cover the ingot, then the ingot covered with the mixture is pressed into a cylinder with the diameter of 3 cm and the height of 3 cm, which is the reaction ingot described above. This reaction ingot is then placed into a space within the adiabatic device, and the gap between the adiabatic device and the cylinder is filled with the isolation powder. Usually the insulation powder containing aluminum nitride. The adiabatic device and the cylinder are placed inside a sealed reactor, i.e. the chamber 2 in FIG. 1. The chamber is firstly vacuum pumped and then filled with the 5 atmospheric pressure of nitrogen gas, the tungsten coil, i.e. the heater 27 in FIG. 1, inside the chamber is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the photoluminescence (PL) analysis, the product emits the visible light in the yellow wavelength of 400 nm to 670 nm.

### Embodiment 2

Ca, Si, Al, Al₂O₃, Si₃N₄, NaN₃, NH₄Cl and Eu₂O₃ are uniformly mixed according to the molar ratio of 0.8:7.7:2:0.4:0.5:9.936:4.829:0.03, and then are pressed into the cylindrical ingot with the diameter of 1.7 cm and the height of 1.7 cm by using the mold press. Then Mg and Fe₃O₄, i.e. the combustion initiator raw material 4′ shown in FIG. 2 are uniformly mixed according to the molar ratio of 4:1. This mixture is used to cover the ingot, then the ingot covered with the mixture is pressed into the cylinder with the diameter of 3 cm and the height of 3 cm, which is the reaction ingot described above. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 5 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 680 nm.

### Embodiment 3

Ca, Si, Al, Al₂O₃, Si₃N₄, NaN₃, NH₄Cl and Eu₂O₃ are uniformly mixed according to the molar ratio of 0.8:6.2:2:0.4:1:9.936:4.829:0.03, and then are pressed into the cylindrical ingot with the diameter of 1.7 cm and the height of 1.7 cm by using the mold press. Then Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 3 cm and the height of 3 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 5 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 670 nm.

### Embodiment 4

Ca, Si, Al, Al₂O₃, Si₃N₄, NaN₃, NH₄Cl and Eu₂O₃ are uniformly mixed according to the molar ratio of 0.8:7.7:2:0.4:0.5:11:4.829:0.03, and then are pressed into the cylindrical ingot with the diameter of 1.7 cm and the height of 1.7 cm by using the mold press. Then Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 3 cm and the height of 3 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 5 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 680 nm.

### Embodiment 5

Ca, Si, Al, Al₂O₃, Si₃N₄, NaN₃, NH₄Cl and Eu₂O₃ are uniformly mixed according to the molar ratio of 0.8:7.7:2:0.4:0.5:14:4.829:0.03, and then are pressed into the cylindrical ingot with the diameter of 1.7 cm and the height of 1.7 cm by using the mold press. Then Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 3 cm and the height of 3 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 5 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 700 nm.

### Embodiment 6

Ca, Si, Al, Al₂O₃, Si₃N₄, NaN₃, NH₄Cl and Eu₂O₃ are uniformly mixed according to the molar ratio of 0.8:7.7:2:0.4:0.5:18:4.829:0.03, and then are pressed into the cylindrical ingot with the diameter of 1.7 cm and the height of 1.7 cm by using the mold press. Then Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 3 cm and the height of 3 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 5 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 670 nm.

### Embodiment 7

Ca, Si, Al, Al₂O₃, Si₃N₄, NaN₃, NH₄Cl and Eu₂O₃ are uniformly mixed according to the molar ratio of 0.8:7.7:2:0.4:0.5:9.936:4:0.03, and then are pressed into the cylindrical ingot with the diameter of 1.7 cm and the height of 1.7 cm by using the mold press. Then Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 3 cm and the height of 3 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 5 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 670 nm.

### Embodiment 8

Ca, Si, Al, Al₂O₃, Si₃N₄, NaN₃, NH₄Cl and Eu₂O₃ are uniformly mixed according to the molar ratio of 0.8:7.7:2:0.4:0.5:9.936:4.829:0.18, and then are pressed into the cylindrical ingot with the diameter of 1.7 cm and the height of 1.7 cm by using the mold press. Then Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 3 cm and the height of 3 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 5 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 680 nm.

### Embodiment 9

Ca, Si, Al Al₂O₃, Si₃N₄, NaN₃, NH₄Cl and Eu₂O₃ are uniformly mixed according to the molar ratio of 0.8:7.7:2:0.4:0.5:9.936:4.829:0.05, and then are pressed into the cylindrical ingot with the diameter of 1.7 cm and the height of 1.7 cm by using the mold press. Then Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 3 cm and the height of 3 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 5 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 670 nm.

### Embodiment 10

Ca, Si, Al, Al₂O₃, Si₃N₄, NaN₃, NH₄Cl and Eu₂O₃ are uniformly mixed according to the molar ratio of 0.8:7.7:2:0.4:0.5:9.936:4.829:0.07, and then are pressed into the cylindrical ingot with the diameter of 1.7 cm and the height of 1.7 cm by using the mold press. Then. Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 3 cm and the height of 3 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 5 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 680 nm.

### Embodiment 11

Ca, Si, Al, Al₂O₃, Si₃N₄, NaN₃, NH₄Cl and Eu₂O₃ are uniformly mixed according to the molar ratio of 0.8:7.7:2:0.4:0.5:9.936:4.829:0.09, and then are pressed into the cylindrical ingot with the diameter of 1.7 cm and the height of 1.7 cm by using the mold press. Then Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 3 cm and the height of 3 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 5 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 680 nm.

### Embodiment 12

Ca, Si, Al, Al₂O₃, Si₃N₄, NaN₃, NH₄Cl and Eu₂O₃ are uniformly mixed according to the molar ratio of 0.8:7.7:2:0.4:0.5:9.936:4.829:0.03, and then are pressed into the cylindrical ingot with the diameter of 1.7 cm and the height of 1.7 cm by using the mold press. Then Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 3 cm and the height of 3 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 5 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 680 nm.

### Embodiment 13

Ca, Si, Al, Al₂O₃, Si₃N₄, NaN₃, NH₄Cl and Eu₂O₃ are uniformly mixed according to the molar ratio of 0.8:9.2:2:0.4:0:9.936:4.829:0.03, and then are pressed into the cylindrical ingot with the diameter of 1 cm and the height of 1 cm by using the mold press. Then Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 1.7 cm and the height of 1.7 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 5 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 670 nm.

### Embodiment 14

Ca, Si, Al, Al₂O₃, Si₃N₄, NaN₃, NH₄Cl and Eu₂O₃ are uniformly mixed according to the molar ratio of 0.8:7.7:2:0.4:0.5:9.936:4.829:0.03, and then are pressed into the cylindrical ingot with the diameter of 1 cm and the height of 1 cm by using the mold press. Then Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 1.7 cm and the height of 1.7 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 5 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 670 nm.

### Embodiment 15

Ca, Si, Al, Al₂O₃, Si₃N₄, NaN₃, NH₄Cl and Eu₂O₃ are uniformly mixed according to the molar ratio of 0.8:7.7:2:0.4:0.5:9.936:4.829:0.03, and then are pressed into the cylindrical ingot with the diameter of 1 cm and the height of 1 cm by using the mold press. Then Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 3 cm and the height of 3 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 5 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 670 nm.

### Embodiment 16

Ca, Si, Al, Al₂O₃, Si₃N₄, NaN₃, NH₄Cl and Eu₂O₃ are uniformly mixed according to the molar ratio of 0.8:7.7:2:0.4:0.5:9.936:4.829:0.03, and then are pressed into the cylindrical ingot with the diameter of 1.7 cm and the height of 1.7 cm by using the mold press. Then Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 3 cm and the height of 3 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 7 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 670 nm.

### Embodiment 17

Ca, Si, Al, Al₂O₃, Si₃N₄, NaN₃, NH₄Cl and Eu₂O₃ are uniformly mixed according to the molar ratio of 0.8:7.7:2:0.4:0.5:9.936:4.829:0.03, and then are pressed into the cylindrical ingot with the diameter of 1.7 cm and the height of 1.7 cm by using the mold press. Then Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 3 cm and the height of 3 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 9 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 670 nm.

### Embodiment 18

Ca, Si, Al, Al₂O₃, Si₃N₄, NaN₃, NH₄Cl and Eu₂O₃ are uniformly mixed according to the molar ratio of 0.8:7.7:2:0.4:0.5:9.936:4.829:0.03, and then are pressed into the cylindrical ingot with the diameter of 1.7 cm and the height of 1.7 cm by using the mold press. Then Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 3 cm and the height of 3 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 5 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 680 nm.

### Embodiment 19

Ca, Si, Al, Al₂O₃, Si₃N₄, NaN₃, NH₄Cl and CeO₂ are uniformly mixed according to the molar ratio of 0.8:7.7:2:0.4:0.5:9.936:4.829:0.06, and then are pressed into the cylindrical ingot with the diameter of 1.7 cm and the height of 1.7 cm by using the mold press. Then Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 3 cm and the height of 3 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 5 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow-green wavelength of 400 nm to 650 nm.

### Embodiment 20

Ca, Si, Al, Al₂O₃, Si₃N₄, NaN₃, NH₄Cl and Eu₂O₃ are uniformly mixed according to the molar ratio of 0.8:7.7:2:0.4:0.5:10:4.829:0.03, and then are pressed into the cylindrical ingot with the diameter of 1.7 cm and the height of 1.7 cm by using the mold press. Then Mg and Fe₃O₄, are uniformly mixed according to the molar ratio of 4:1. This mixture is used to fully cover the ingot, and then the ingot covered with the mixture is pressed into the reaction ingot with the shape of cylinder with the diameter of 3 cm and the height of 3 cm. This reaction ingot is then placed into a space within the adiabatic device, and the gap between the adiabatic device and the cylinder is filled with the aluminum nitride powder. The adiabatic device and the cylinder are placed inside a sealed reactor. The sealed reactor is firstly vacuum pumped and then filled with the 5 atmospheric pressure of nitrogen gas, the tungsten coil inside the sealed reactor is applied with electrical current to heat the upper portion of the cylinder to ignite Mg and Fe₃O₄ for the reaction, the combustion wave of the combustion initiator will spread downwards, the internal nitridation reaction of the reactants occur immediately, and the reaction is completed in about 1 to 3 seconds. The product is pale yellow powder, is processed by simple grinding, and is then identified by the X-ray Diffraction (XRD). The product has Ca-α-SiAlON lattice structure as shown by the XRD identification. By the PL analysis, the product emits the visible light in the yellow wavelength of 400 nm to 670 nm.

The luminescence materials with the main lattice of α-SiAlON are synthesized by applying the principle of the combustion synthesis in the present invention. The synthesis method in the present invention is completely different from those of the conventional techniques. Generally speaking, compared with the conventional techniques, the method of the present invention has the advantages described as follows.

The first advantage is the extremely fast reaction. In the method of the present invention, it only takes a few seconds to heat and ignite the reaction, the combustion synthesis reaction can be completed within tens of seconds after the ignition. In contrast, the conventional methods are performed at very high temperature (1300 to 2200° C.) for several hours to complete the reaction. Compared with the conventional techniques, the method of the present invention has the great advantages of fast reaction and high production rate.

Another advantage is the energy saving. The method of the present invention utilize the large amount of heat generated from the exothermic combustion synthesis reaction to heat the unreacted reactant for the self reaction, and therefore do not need any further energy from the outside. The whole process of the present method only needs the energy from the outside to ignite the combustion initiator before the reaction. This ignition is performed for heating only a small part of the reactants, generally only about 1 kW of power for heating about 5 seconds is enough for the ignition, and the heating power can be turned off after the ignition of the combustion synthesis reaction. In contrast, all the conventional technologies adopts the electric furnace to heat the reactants up to very high temperature, e.g. 2050° C., and have to maintain that high temperature for several hours so as to complete the reaction. The method of the present invention adopts the adiabatic device to reduce heat loss, can effectively improve the energy efficiency, and reduce the usage amount of the combustion initiator. Compared with the conventional technologies, the method of the present invention thus has the apparent effect of the energy saving.

Another advantage is the simple manufacturing process. In the method of the present invention, the reactant powder and the ion source as an activator are mixed together according to an appropriate ratio to form the mixed reactant powder, which is ignited for the combustion synthesis reaction, and then the powder product can be obtained. Thus, the manufacturing process of the present invention includes only a single step. In contrast, most of the conventional technologies require two or more reaction steps to complete the reaction. For an example of the hydrothermal method, several reactants must be mixed in a solution, which is heated, then the steps of the centrifugal separation, water washing and drying are followed, and after then the heating treatment is required to obtain the luminescence powder. In an example of the solid state reaction method, in addition to the step of mixing the reactants, the step of the cold isostatic pressing or the hot pressure sintering is required, and the step of grinding is also required, since the agglomeration of the product is usually serious. Compared with the conventional technologies, the invention thus has a significant advantage of the simple process.

Another advantage is the low-pressure synthesis. Compared with the conventional combustion synthesis methods, the novel combustion synthesis method of the present invention is carried out at a lower gaseous pressure (<0.5 MPa), thereby the costs of the apparatus and gas can be largely reduced, and the hazard can be accordingly reduced as well.

A further advantage is the simply manufacturing apparatus. The combustion synthesis apparatus used in the method of the present invention has simple configuration, contains a sealed shell-shape space able to be opened and closed and an adiabatic device disposed in the sealed space. Only a heater able to afford a power of 1 kW is required to be disposed in the sealed space, and the overall reaction takes only tens of seconds to complete. Especially, the reaction can be carried out at low pressure, about 5 atmospheric pressure (i.e. about 0.5 MPa). Therefore it is easy to design and build the manufacturing apparatus for the present invention. Only the normal building technique is required to build the manufacturing apparatus for the present invention with low cost. The adiabatic device is built by using the thermal insulation materials and can be constructed easily. The manufacturer is able to produce the excellent products at the low cost with high energy utilization efficiency. In contrast, the reactors of the conventional technologies must be able to work under high nitrogen gas pressure (e.g. higher than 10 atm.) and at extremely high temperatures (e.g. 1800° C. or higher) for several hours. The design and construction of this kind of apparatus for the conventional technologies require high-end building techniques with much higher cost. Therefore, the present invention has the advantages of the simple manufacturing apparatus and low apparatus coat, after the comparison of the present invention with the conventional technologies.

To sum up, the present invention adopts the novel combustion synthesis to manufacture the luminescence powders with the lattice of α-SiAlON, which is manufactured through the heating and ignition of the combustion initiator to provide heat to the reactants for reaction and the utilization of an adiabatic device with the function of thermal insulation. The adiabatic device can reduce this heat loss of reactants, and can concentrate the heat energy on the reactants, so that the reaction time can be shortened, the escape of the gas internally generated can be reduced, the conversion rate can be improved, the impurities in the product can be reduced, accordingly the manufacturing steps can be reduced, the luminescence intensity can be raised and the emission wavelength can be well adjusted. In addition, the high heat generated during the reaction can facilitate the rapid diffusion of the activator ion into the lattice, so that the α-SiAlON luminescence powders with superior performances can be manufactured in very short time. In summary, compared with the conventional technologies, the present invention has the advantages of energy saving, fast reaction, simple manufacturing process, simple manufacturing apparatus, low-pressure synthesis, low production cost, etc., and can make great contributions to the related industries of the light-emitting diodes.

The present invention includes the α-SiAlON luminescence materials, and the manufacturing method and apparatus therefor. While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method of manufacturing a luminescence material having an alpha-SiAlON, comprising steps of:
providing a precursor of the alpha-SiAlON;
mixing an igniting agent with the precursor to obtain a reaction mixture; and
combusting the igniting agent to trigger a reaction of the reaction mixture so as to obtain the luminescence material.

2. A method of claim 1, further comprising a step of placing the reaction mixture into an adiabatic device.

3. A method of claim 2, further comprising a step of disposing an insulation powder between the reaction mixture and the adiabatic device.

4. A method of claim 1, wherein the precursor includes at least a reaction ingot, which is covered by the igniting agent during the step of mixing the igniting agent with the precursor.

5. A method of claim 1, wherein the step of combusting the igniting agent is performed by heating the reaction mixture.

6. A method of claim 1, wherein the igniting agent comprises one selected from a group consisting of a Ti/C mixture, an Mg/Fe₃O₄ mixture, an Al/Fe₃O₄ mixture, an Al/Fe₂O₃ and a combination thereof.

7. A method of claim 1, wherein the igniting agent includes an Mg/Fe₃O₄ mixture having a molar ratio of the Mg to the Fe₃O₄ in a range of 1 to 8.

8. A method of claim 1, wherein the precursor comprises a solid nitrogen source including one selected from a group consisting of an NaN₃, a KN₃, a Ba₃N₂ and a combination thereof.

9. A method of claim 1, wherein the precursor comprises an ammonium halide source.

10. A method of claim 1, further comprising a step of placing the reaction mixture into a chamber.

11. A method of claim 1, wherein the precursor comprises plural reaction ingots to be mixed with the igniting agent, and the step of combusting the igniting agent is performed by sequentially heating the plural reaction ingots.

12. A luminescence material comprising an alpha-SiAlON, and having a composition formula of Mₓ(Si, Al)₁₂(O, N)₁₆:A_{y}, herein the M is a cation, the A is an ion of an activator, the x is a relative molar number of the M, and the y is a relative molar number of the A.

13. A luminescence material of claim 12, further comprising at least an element being one selected from a group consisting of a sodium, a chlorine and an iron.

14. A luminescence material of claim 12, further comprising a sodium chloride.

15. A luminescence material of claim 12, wherein the M comprises at least an element being one selected from a group consisting of an Mg, a Ca and a Y.

16. A luminescence material of claim 12, wherein the A comprises at least an element being one selected from a group consisting of an Eu, a Ce, a Tb and a rare earth element.

17. An apparatus for manufacturing a luminescence material having an alpha-SiAION, comprising:
an adiabatic device accommodating a raw material for manufacturing the luminescence material; and
a heater disposed adjacent to the adiabatic device for heating the raw material to obtain the luminescence material.

18. An apparatus of claim 17, further comprising a chamber, wherein the adiabatic device and the heater are disposed inside the chamber.

19. An apparatus of claim 17, further comprising an insulation powder disposed between the raw material and the adiabatic device.

20. An apparatus of claim 19, wherein the insulation powder comprises a ceramic powder.
